(19) United States
(12) Patent Application Publication
(10) Pub. No.: US 2022/0340745 A1
(43) Pub. Date: Oct. 27, 2022

(54) FLUOROPOLYMER COMPOSITION AND METHOD TO MAKE

(71) Applicant: Arkema Inc., King of Prussia, PA (US)

(72) Inventors: Florence Mehlmann, King of Prussia, PA (US); James T. Goldbach, King of Prussia, PA (US); Anthony Bonnet, Colombes (FR)

(21) Appl. No.: 17/765,458

(22) PCT Filed: Oct. 21, 2020
(86) PCT No.: PCT/US2020/056548

§ 371 Date: Mar. 31, 2022

Related U.S. Application Data
(60) Provisional application No. 62/923,743, filed on Oct. 21, 2019.

(51) Int. Cl. C08L 27/16

(52) U.S. Cl. CPC C08L 27/16

(57) ABSTRACT

Disclosed is a composition comprising a PVDF copolymer where at least one comonomer is selected from Hexafluoropropene, 2,3,3,3-tetrafluoropropylene, 3,3,3-trifluoropropene, from 0.005-5% of one or more inorganic or polymeric nucleating additives and 0.01-20% of one or more dispersing agents having reduced haze. Also disclosed is a method of preparing the composition.

### FIELD OF THE INVENTION

The invention provides a composition and method to enable fine dispersion of inorganic or polymeric nucleating additives into fluorinated copolymers.

### BACKGROUND OF THE INVENTION

PVDF homopolymers have high crystallinity which enables excellent physical properties. In some applications, VDF is copolymerized with other fluorinated comonomers to make PVDF copolymers. Comonomers such as hexafluoropropene, 2,3,3,3-tetrafluoropropene, 3,3,3-trifluoropropene, tend to decrease the melting point of PVDF and decrease the kinetics of crystallization. This leads to material parts with inconsistent physical properties, including optical haze.

### SUMMARY OF THE INVENTION

The invention provides a method which uses inorganic or polymeric nucleating additives to increase the kinetics of crystallization of PVDF copolymers. Some inorganic and polymeric nucleating additives have been described for polyolefins and for PVDF homopolymers. We have now found that select nucleating additives, such as carbon black and PTFE polymer, can be used efficiently in PVDF copolymers resulting in reduced haze of parts made of the copolymers. Further, the invention provides the use of dispersing agents to facilitate the dispersion of nucleating additives in the copolymers. Since the PVDF copolymers are more hydrophobic than PVDF homopolymers, the dispersion of nucleating additive is a challenge. Poor dispersion of the nucleating additive can lead to high optical haze, due to the size of the nucleating additive itself in the final material. The dispersing agent allows for the nucleating additive to be present in the composition as small particles (discrete domains in the copolymer matrix), with more than 50%, preferably more than 70%, most preferably more than 90% of the particles having a size of less than 5 microns, preferably less than 2 microns, most preferably less than 1 micron. The invention also provides methods of making the composition with the low optical haze of less than 30%, preferably less than 20%, when measured by ASTM D1003 on a 1 mm part compression molded using the composition.

### Aspects of the Invention:

Aspect 1: A composition comprising
a. a PVDF copolymer where at least one comonomer is selected from hexafluoropropene, 2,3,3,3-tetrafluoropropylene, 3,3,3-trifluoropropene, and wherein VDF makes up more than 60% of all monomers, preferably more than 70% of all monomers, and
b. 0.005-5% of one or more inorganic or polymeric nucleating additives, and
c. 0.1-20% of one or more dispersing agents, wherein optical haze of a 1 mm thick part of made by compression molding at 230 C is less than 40% per ASTM D1003.

Aspect 2: The composition of aspect 1 wherein the dispersing agent is present at 1-15%.

Aspect 3: The composition of any one of aspects 1 to 2 wherein said nucleating additive is present as particles, with more than 50%, preferably more than 70%, most preferably more than 90% of the particles having a size of less than 5 microns, preferably less than 2 microns, most preferably less than 1 micron.

Aspect 4: The composition of any one of aspects 1 to 2 wherein said nucleating additive has an average particle size of less than 2 microns, most preferably less than 1 micron.

Aspect 5: The composition of any one of aspects 1 to 4 wherein said nucleating additive is selected from the group of inorganic particles, organic dyes, benzene derivatives, fluorinated polymers, crosslinked polymer particles and combinations thereof.

Aspect 6: The composition of aspect 5 where inorganic particles are selected from carbon black, activated carbon, silica, clay, aluminosilicates, talc, mica, calcium carbonate, titania and combinations thereof.

Aspect 7: The composition of aspect 5 where organic dyes are selected from flavanthrone, idanthrone, perlyene, quinophtalone, phtalocyanine and combinations thereof.

Aspect 8: The composition of aspect 5 where fluorinated polymers are selected from polytetrafluoroethylene polymers and copolymers.

Aspect 9: The composition of aspect 5 where crosslinked polymer particles are selected from polymer made by suspension or emulsion polymerization in the presence of a crosslinking monomer.

Aspect 10: The composition of any one of aspects 1 to 9 where said dispersing agent is selected from one or more plasticizers.

Aspect 11: The composition of aspect 10 where said plasticizers are selected from the group consisting of acrylics, styrenics, polyesters and combinations thereof.

Aspect 12: The composition of aspect 11 wherein said acrylic polymers are selected from poly(methyl methacrylate) oligomers, polymers and copolymers.

Aspect 13: The composition of aspect 11 wherein said polyesters are selected from the group consisting of polyethylene glycol, polypropylene glycol and blends thereof.

Aspect 14: A method of preparing the composition of any of aspects 1 to 13 comprising the steps of
d. Mixing nucleating additive with dispersing agent in a mixer or an extruder
e. Mixing the blend of (d) with the VDF-based copolymer in an extruder.

Aspect 15: A method of preparing the composition of anyone of aspects 1 to 13 including the steps of
f. mixing a latex of VDF-based copolymer with nucleating additive and/or dispersing agent, and
g. drying the latex into a solid material.

Aspect 16: An article comprising the composition of any one of aspects 1 to 13, where said article can be a film, sheet, rod, multilayer part, or any other shape and geometry.

Aspect 17: The article of claim 16 wherein the article is a melt processed article.

Aspect 18: The use of the article of aspect 17 for wire and cable, oil and gas, consumer electronic, photovoltaic, protective films, packaging, medical devices.

### BRIEF DESCRIPTION OF THE FIGURES

FIG. 1: Optical image of part made in Comparative Example 1 (Nikon ME600 optical microscope).

FIG. 2: Optical image of part made in Example 1 (Nikon ME600 optical microscope).

### DESCRIPTION OF THE INVENTION

The references cited in this application are incorporated herein by reference.

Percentages, as used herein are weight percentages, unless noted otherwise, and molecular weights are weight average molecular weights, unless otherwise stated.

“Copolymer” is used to mean a polymer having two or more different monomer units. “Polymer” is used to mean both homopolymer and copolymers. For example, as used herein, “PVDF” and “polyvinylidene fluoride” is used to connote both the homopolymer and copolymers, unless specifically noted otherwise. Polymers may be straight chain, branched, star, comb, block, cross-linked or any other structure. The polymers may be homogeneous, heterogeneous, and may have a gradient distribution of co-monomer units. As used herein, unless otherwise described, percent shall mean weight percent. Molecular weight is a weight average molecular weight as measured by gas permeation chromatography (GPC). An alternative to GPC used to quantify molecular weight is melt flow rate (MFR)—where higher molecular weight (MW) has a lower MFR, or melt viscosity (MV) measured at 230° C. at 100 sec-1, where higher MW resins show higher MV. An “extrusion” grade product would most frequently have a MV of between 12-40 kpoise at 100 sec-1 at 232° C. for PVDF polymers. An “injection molding” grade would have an MV of between 1-11 kpoise.

Particle size of polymeric powder can be measured using a Malvern Masturizer 2000 particle size analyzer. The data is reported as volume average particle size (diameter).

Powder/latex average discrete particle size is measured using a NICOMP™ 380 submicron particle sizer. The data is reported as volume average particle size (diameter). Discrete means the particles have not agglomerated.

### PVDF Copolymers

The term PVDF copolymers denotes copolymers of vinylidene fluoride VDF containing one or more other fluorinated comonomers. The PVDF copolymers of the invention are those in which vinylidene fluoride units comprise greater than 50 percent of the total weight of all the monomer units in the polymer, more preferably comprise greater than 60 percent of the total weight of the units, and most preferably comprise greater than 70 percent of the total weight of the units. The fluorinated comonomer(s) comprises at least 0.5%, preferably at least 1%, more preferably at least 4% by weight of the PVDF copolymer. The fluorinated comonomer(s) are from 0.5% to 30 wt percent, preferably from 1% to 20 wt %.

Fluorinated comonomers are chosen from compounds containing a vinyl group capable of opening in order to be polymerized and that contains, directly attached to this vinyl group, at least one fluorine atom, at least one fluoroalkyl group or at least one fluoroalkoxy group except VDF as it is already present in the PVDF copolymer. Examples of fluorinated comonomers include, but are not limited to vinyl fluoride; trifluoroethylene (VF3); chlorotrifluoroethylene (CTFE); 1,2-difluoroethylene; tetrafluoroethylene (TFE); hexafluoropropylene (HFP); 2,3,3,3-tetrafluoropropylene; 1,3,3,3-tetrafluoropropylene; 3,3,3-trifluoropropylene; perfluoro(alkyl vinyl) ethers, such as perfluoro(methyl vinyl) ether (PMVE), perfluoro(ethyl vinyl) ether (PEVE) and perfluoro(propyl vinyl) ether (PPVE); perfluoro(1,3-dioxole); perfluoro(2,2-dimethyl-1,3-dioxole) (PDD). Preferred PVDF copolymers include copolymers of copolymers of VDF and HFP, copolymers of VDF and 2,3,3,3-tetrafluoropropylene, copolymers of VDF and 3,3,3-trifluoropropylene, terpolymers of VDF, HFP, and TFE (THV).

The PVDF copolymer can be a copolymer of VDF and HFP. In one embodiment, from at least 1% up to 30%, preferably up to 25%, and more preferably up to 15% by weight of hexafluoropropene (HFP) units and at least 70%, preferably at least 75%, more preferably at least 85% by weight or more of VDF units are present in the PVDF copolymer.

The PVDF copolymer for use in the invention has a high molecular weight. By high molecular weight, as used herein is meant having a melt viscosity of greater than 1.0 kilopoise, preferably greater than 5 kilopoise, according to ASTM method D-3835 measured at 450° F. and 100 sec⁻¹.

The PVDF copolymer used in the invention is generally prepared by means known in the art, using aqueous free-radical emulsion polymerization—although suspension, solution and supercritical CO₂ polymerization processes may also be used. In a general emulsion polymerization process, a reactor is charged with deionized water, water-soluble surfactant capable of emulsifying the reactant mass during polymerization and optional paraffin wax antifoulant. The mixture is stirred and deoxygenated. A predetermined amount of chain transfer agent, CTA, is then introduced into the reactor, the reactor temperature raised to the desired level and vinylidene fluoride and one or more comonomers are fed into the reactor. Once the initial charge of vinylidene fluoride and comonomers is introduced and the pressure in the reactor has reached the desired level, an initiator emulsion or solution is introduced to start the polymerization reaction. The temperature of the reaction can vary depending on the characteristics of the initiator used and one of skill in the art will know how to do so. Typically, the temperature will be from about 30° to 150° C., preferably from about 60° to 120° C. Once the desired amount of polymer has been reached in the reactor, the monomer feed will be stopped, but initiator feed is optionally continued to consume residual monomer. Residual gases (containing unreacted monomers) are vented and the latex recovered from the reactor.

The surfactant used in the polymerization can be any surfactant known in the art to be useful in PVDF emulsion polymerization, including perfluorinated, partially fluorinated, and non-fluorinated surfactants. Preferably, the PVDF copolymer emulsion of the invention is fluorosurfactant free, with no flurosurfactants being used in any part of the polymerization. Non-fluorinated surfactants useful in the PVDF polymerization could be both ionic and non-ionic in nature including, but are not limited to, 3-allyloxy-2-hydroxy-1-propane sulfonic acid salt, polyvinylphosphonic acid, polyacrylic acids, polyvinyl sulfonic acid, and salts thereof, polyethylene glycol and/or polypropylene glycol and the block copolymers thereof, alkyl phosphonates and siloxane-based surfactants. In one embodiment, the emulsion polymerization is surfactant-free.

The PVDF copolymerization results in a latex generally having a solids level of 10 to 60 percent by weight, preferably 10 to 50 percent, and having a latex volume average particle size of less than 500 nm, preferably less than 400 nm, and more preferably less than 300 nm. The discrete volume average particle size is generally at least 20 nm and preferably at least 50 nm.

A minor amount (preferably less than 10 wt percent, preferably less than 5 wt %) of one or more other water-miscible solvents, such as ethylene glycol, may be mixed into the PVDF latex to improve freeze-thaw stability.

The PVDF copolymer latex may be used in the invention process as a latex, or it may be first dried to a powder by means known in the art, such as, but not limited to, spray drying, freeze-drying, coagulating, and drum drying. The dried PVDF copolymer powder has a volume average particle size of from 0.5 to 200 microns, preferably from 1 to 100 microns, more preferably from 2 to 50 microns, and most preferably from 3 to 20 microns.

In one embodiment, copolymers of VDF and HFP are used. Especially useful copolymers include, but are not limited to KYNAR™ resins from Arkema Inc., especially KYNAR 2500, KYNAR 2750, KYNAR 2800, KYNAR 2850.

PVDF/HFP copolymers have a lower melting point, lower crystallinity and slower crystallization kinetics than PVDF homopolymers. The latter is especially an issue in making a material with low optical haze, as the optical haze becomes very dependent on the melt process and cooling process used to make a plastic part from the copolymer.

The Haze value can be reduce by more than 10%, preferably more than 20% and even more preferably by more than 40% comparing the composition containing the dispersant and nucleating agent to the same composition without the dispersant and nucleating agent.

For example, copolymers of VDF and HFP containing up to 22 wt % HFP can be compression molded or injection molded or extruded into 1 mm parts that will have high haze of more than 40%. In general, slower cooling typical of compression molding will produce parts with higher haze. The compositions of the invention can be processed into 1 mm parts with low haze of 40% or less.

In one variant of the invention, the PVDF copolymer is a functional PVDF copolymer, such as maleic anhydride-grafted. The functionality improves the compatibility of the polymer with additives of this invention.

### Nucleating Additives

The nucleating additive is selected from inorganic or polymeric materials.

There can be one or more nucleating additives present. The total amount of nucleating additive in the present invention will be at least 0.005 and no more than 15% by weight based on the total composition.

The amount of any one nucleation additive can be from 0.005-10%, preferably from 0.05 to 5%, more preferably from 0.09 to 3.5% by weight based on the total composition.

Examples of nucleating additive included, but are not limited to, inorganic particles, organic dyes, benzene derivatives, perfluorinated polymers, crosslinked polymer particles.

Example of inorganic nucleating additives include but are not limited to carbon black, activated carbon, silica, clay, aluminosilicates, talc, mica, calcium carbonate, titania. Example of organic dyes nucleating additives include but are not limited to flavanthrone, idanthrone, perlyene, quinophtalone, phtalocyanine. Examples of fluorinated polymers include but are not limited to polytetrafluoroethylene polymers and copolymers. One example fluorinated polymer nucleating additive is perfluorinated polytetrafluoroethylene (PTFE). Examples of crosslinked polymer particles nucleating additives include but are not limited polymer made by suspension or emulsion polymerization in the presence of a crosslinking monomer.

### Dispersing Agents

The amount of dispersing agent used in the invention is from 0.1-20% of one or more dispersing agents, preferably from 1 to 15%, more preferably from 2 to 10% based on the total composition.

The dispersing agent can be one or more plasticizers. Examples of dispersing agents include acrylics, styrenics, and polyesters. Acrylics include but are not limited to poly(methyl methacrylate) oligomers, polymers and copolymers. Polyesters include but are not limited to polyethylene glycol and polypropylene glycol. Acrylics and polyesters are preferred.

### Mixing Process

The PVDF copolymers, the dispersion agent and the nucleating additive can be mixed in an aqueous media followed by drying into a particulate material, or they can be mixed as solid materials. Dispersion agents can be mixed with the PVDF copolymers and nucleating additive in one step, or can be first mixed with the nucleating additive, then subsequently mixed with the PVDF copolymers, or can be first mixed with the PVDF copolymers, then subsequently mixed with the nucleating additive. Any mixing equipment known in the art can be utilized, including static mixers, brabenders, extruders.

In one embodiment, an intimate blend of the PVDF copolymer, nucleating additive and dispersing agent can be prepared by co-spray drying the components mixed in an aqueous media. One could mix together an effective amount of PVDF copolymer latex with nucleating additives (in latex, solution, or solid form), and with dispersing agent (in latex, solution, or solid form), and co-spray them to achieve a dry powder that is well mixed at nano-scale. This co-spray dried complex can then be processed into the desired shape by any melt process know in the art, such as compression molding, injection molding, extrusion, coextrusion. Use of PVDF latex with small particle size (generally 20-400 nm) to make the inventive blend provides an extremely intimate blend that allows for excellent dispersion of the nucleating additive in the material and helps further reduce the optical haze.

### Uses

Due to the advantageous properties of PVDF copolymers, including chemical inertness, biological purity, and excellent mechanical and thermo mechanical properties, now combined with consistent low haze, the composition of this invention can find use in many applications.

The composition of the present invention are melt processed to produce articles. The articles of the present invention are melt processed articles.

Some articles made with the composition of the invention include, but are not limited to films, sheet, rods, multilayer parts. Applications may include wire and cable, oil and gas, consumer electronic, photovoltaic, protective films, packaging, medical devices.

### EXAMPLES

### Comparative Example 1

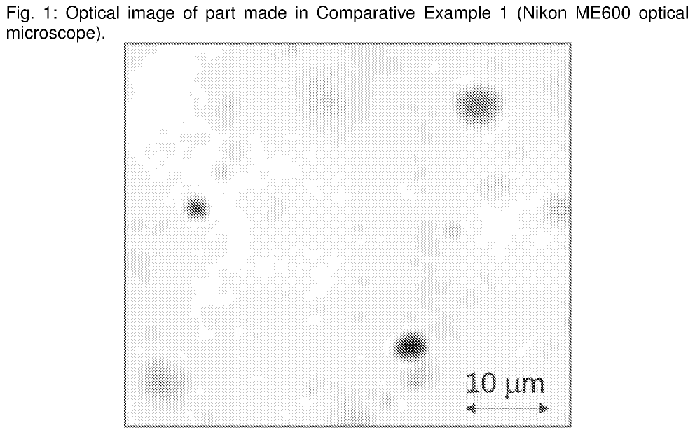

A copolymer of VDF/HFP (15 wt % HFP) is combined with nucleating additive carbon black with discrete particle size of 20 nm (0.05 wt % of the blend), in a twin screw extruder at 230 C to produce pellets. The pellets are compression molded into 1 mm thick plaques at 230 C under 5 MT of pressure, and cooled down to room temperature over 10 minutes. A control 1 mm plaque of the pure VDF/HFP copolymer is also compression molded in the same conditions. ASTM D1003 is used to measure the haze of the sample plaques. The pure copolymer has a haze of 72% and the blend of the copolymer and carbon black has a haze of 65%. The reduction of haze with addition of the carbon black shows that it is working as a nucleating additive and producing smaller alpha crystals that don't diffract light as much. However, the reduction of haze is limited by the poor dispersion of the 20 nm carbon black particles, which are present in the final material as agglomerates larger than 1 micron. Indeed, optical microscopy shows that more than 70% carbon black particles are present in the form of agglomerates of 2 microns or larger (FIG. 1).

### Example 1

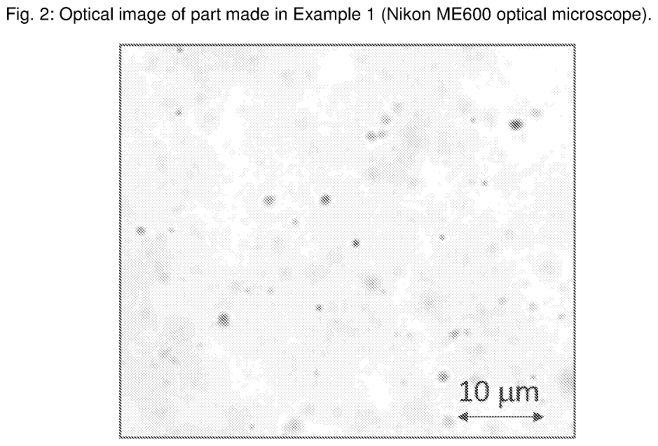

An acrylic polymer from Arkema, Plexiglas V825-100 is first mixed with 0.5 wt % of carbon black with discrete particle size of 20 nm, in a high shear mixer (dry blend). The resulting material is then blended at 10 wt % with a copolymer of VDF/HFP (15 wt % HFP)(dry) in a twin screw extruder at 230 C to produce pellets. The final material contains VDF/HFP polymer 9.95 wt % of dispersing agent V825-100 and 0.05 wt % of nucleating additive carbon black. Pellets are compression molded into 1 mm thick plaques at 230 C under 5 MT of pressure, and cool down to room temperature over 10 minutes. ASTM D1003 is used to measure the haze of the sample plaque. Haze is 35%. The haze is much lower than that obtained in comparative example 1, demonstrating the effect of the dispersing agent. Indeed, optical microscopy shows carbon black particles with size of less than 2 microns, with less than 30% of carbon black present in the form of agglomerates larger than 2 microns (FIG. 2).

### Example 2

An acrylic copolymer from Dow, Paraloid B-44 is first mixed with 0.5 wt % of carbon black with discrete particle size of 20 nm, in a high shear mixer (dry blend). The resulting material is then blended at 10 wt % with a copolymer of VDF/HFP (15 wt % HFP)(dry) in a twin screw extruder at 230 C to produce pellets. The final blended material contains VDF/HFP polymer, 9.95 wt % of dispersing agent B-44 and 0.05 wt % of nucleating additive carbon black. Pellets are compression molded into 1 mm thick plaques at 230 C under 5 MT of pressure, and cool down to room temperature over 10 minutes. ASTM D1003 is used to measure the haze of the sample plaque. Haze is 38%. The haze is much lower than that obtained in comparative example 1, demonstrating the effect of the dispersing agent. Indeed, optical microscopy shows carbon black particles with size of less than 1 micron, with less than 20% of carbon black present in the form of agglomerates larger than 1 micron.

### Comparative Example 3

A blend is made of copolymer of VDF/HFP (15 wt % HFP) and nucleating additive PTFE with discrete particle size of 200 nm (0.05 wt % of blend) (wet aqueous blend). Both materials are used in the form of a latex. They are mixed in a centrifugal planetary mixer to produce a latex blend, which is then dried in an oven at 80 C for 12 hours. The obtained powder is compression molded into 1 mm thick plaques at 230 C under 5 MT of pressure, and cooled down to room temperature over 10 minutes. A control 1 mm plaque of the pure VDF/HFP copolymer is also compression molded in the same conditions. ASTM D1003 is used to measure the haze of the sample plaques. The pure copolymer has a haze of 72% and the blend of the copolymer and PTFE has a haze of 61%. The reduction of haze with addition of the PTFE shows that it is working as a nucleating additive and producing smaller alpha crystals that don't diffract light as much. However, the reduction of haze is limited, and we hypothesize that it is due to the poor dispersion of the 200 nm PTFE particles, which are likely to agglomerate in to particles larger than 1 micron, just like we observed with carbon black.

### Example 3

A blend is made of copolymer of VDF/HFP (15 wt % HFP), nucleating additive PTFE and discrete particle size of 200 nm (0.05 wt % of the blend) and acrylic polymer (9.95% of blend) from Arkema, Plexiglas V825-100 is made. Latexes of the VDF/HFP copolymer and PTFE are first mixed in a centrifugal planetary mixer to produce a latex blend, which is then dried in an oven at 80 C for 12 hours. The obtained dried powder is then blended with the acrylic polymer (dry) in a twin screw extruder at 230 C to produce pellets. The pellets are compression molded into 1 mm thick plaques at 230 C under 5 MT of pressure, and cooled down to room temperature over 10 minutes. ASTM D1003 is used to measure the haze of the sample plaque. Haze is 36%. The haze is much lower than that obtained in comparative example 3, demonstrating the effect of the dispersing agent. We hypothesize that the dispersing agent helps break agglomerates of the 200 nm discrete PTFE particles.

1. A composition comprising
a. a PVDF copolymer where at least one comonomer is selected from the group consisting of hexafluoropropene, 2,3,3,3-tetrafluoropropylene and 3,3,3-trifluoropropene, and wherein VDF makes up more than 60% of all monomers, and
b. 0.005-5% of one or more inorganic or polymeric nucleating additives, and
c. 0.-1-20% of one or more dispersing agents selected from the group of acrylic polymers and polyesters,
wherein the optical haze of a 1 mm thick part made by compression molding at 230 C is less than 40% per ASTM D1003.

2. The composition of claim 1, comprising 1-15% of one or more dispersing agents.

3. The composition of claim 1, wherein said nucleating additive is present as particles, with more than 50% of the particles having a size of less than 5 microns.

4. The composition of claim 1, wherein said nucleating additive has an average particle size of less than 2 microns.

5. The composition of claim 1, wherein said nucleating additive is selected from the group consisting of inorganic particles, organic dyes, benzene derivatives, fluorinated polymers, crosslinked polymer particles and combinations thereof.

6. The composition of claim 5, wherein the inorganic particles are selected from the group consisting of carbon black, activated carbon, silica, clay, aluminosilicates, talc, mica, calcium carbonate, titania and combinations thereof.

7. The composition of claim 5, wherein the organic dyes are selected from the group consisting of flavanthrone, idanthrone, perlyene, quinophtalone, phtalocyanine and combinations thereof.

8. The composition of claim 5, wherein the nucleating additive comprises fluorinated polymers selected from polytetrafluoroethylene polymers and copolymers.

9. The composition of claim 5, wherein the crosslinked polymer particles are selected from polymers made by suspension or emulsion polymerization in the presence of a crosslinking monomer.

10. The composition of claim 1, wherein said dispersing agent comprises one or more plasticizers.

11. The composition of claim 10 where said plasticizers are selected from the group consisting of acrylics, styrenics, polyesters and combinations thereof.

12. The composition of claim 11, wherein said acrylics are selected from poly(methyl methacrylate) oligomers, polymers and copolymers.

13. The composition of claim 11, wherein said polyesters are selected from the group consisting of polyethylene glycol, polypropylene glycol and blends thereof.

14. A method of preparing the composition of claim 1, comprising the steps of
d. Mixing nucleating additive with dispersing agent in a mixer or an extruder,
e. Mixing the blend of (d) with the VDF-based copolymer in an extruder.

15. A method of preparing the composition of claim 1, comprising the steps of
f. mixing a latex of VDF-based copolymer with nucleating additive and/or dispersing agent, and
g. drying the latex into a solid material.

16. An article comprising the composition of claim 1, where said article can be a film, sheet, rod, multilayer part, or any other shape and geometry.

17. The article of claim 16, wherein the article is a melt processed article.

18. (canceled)
